(19) United States
(12) Patent Application Publication
(10) Pub. No.: US 2009/0200941 A1
(43) Pub. Date: Aug. 13, 2009

(54) Control of mercury leaching

(75) Inventor: Keith A. Klinedinst, Hudson, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/069,842

(22) Filed: Feb. 13, 2008

(51) Int. Cl. H01J 17/26

(52) U.S. Cl. 313/565

(57) ABSTRACT

A safely disposable, mercury-containing lamp includes a component comprising an effective amount of materials to allow the lamp to safely be disposed of, the materials forming a tri-partite component comprising a divalent manganese compound, a copper containing compound and a compound selected from the group consisting of metallic silver and silver containing compounds.

### TECHNICAL FIELD

This invention relates to mercury vapor discharge lamps and more particularly to fluorescent lamps. Still more particularly it relates to lamps that can be landfilled without leaching potentially damaging mercury into the environment.

### BACKGROUND ART

During the manufacture of a fluorescent lamp, as well as other types of arc discharge lamps, a quantity of elemental mercury is sealed within the lamp envelope. It is known that in operation some of the elemental mercury contained in these lamps can be converted to a mercuric oxide or a mercury salt. This is true in fluorescent lamps in particular. In such lamps most of this mercury adheres to the phosphor coating deposited upon the inside wall of the lamp envelope, leaving only a small portion of the mercury in the form of mercury vapor. After the alkaline earth metal oxides coating the lamp electrodes are volatilized, the oxides decompose in the discharge space, and the freed oxygen converts some of this elemental mercury to a salt or compound such as the above-mentioned mercuric oxide (HgO) which is water soluble.

There is a growing concern that a waste stream resulting from the disposal of arc discharge lamps such as fluorescent lamps may leach excessive amounts of soluble mercury into the environment. One method of measuring the amount of soluble mercury, which may leach from the waste stream resulting from the disposal of fluorescent lamps, is described in the Toxicity Characteristic Leaching Procedure (TCLP) prescribed on pages 26987-26998 of volume 55, number 126 of the Jun. 29, 1990 issue of the Federal Register. According to the procedure, the lamp being tested is pulverized into granules having a surface area per gram of material equal to or greater than 3.1 cm² or having a particle size smaller than 1 cm in its narrowest dimension. Following pulverization, the granules are subjected to a sodium acetate buffer solution having a pH of approximately 4.93 and having a weight twenty times the weight of the granules.

At the present time, the Environmental Protection Agency defines a maximum concentration level for mercury at 0.2 milligram leachable mercury per liter extract fluid when the TCLP is applied. According to present standards, a fluorescent lamp is considered nonleachable, and thus available for conventional landfill deposition, when less than 0.2 milligram per liter of leachable mercury results from a TCLP extraction.

Various methods have been proposed which attempt to treat or process burned-out discharge lamps or scrap lamp exhaust tubing containing mercury in order to reclaim the mercury and thereby reduce the amount of mercury-contaminated scrap. These methods are summarized as background in U.S. Pat. No. 5,229,686 and U.S. Pat. No. 5,229,687, which describe methods by which to render a mercury vapor lamp nonleaching upon disposal without the use of expensive treatment processes to reclaim the mercury. The method of U.S. Pat. No. 5,229,686 employs a chemical agent, enclosed within the lamp, suitable for chemically combining a substantial portion of the soluble mercury as a sparingly soluble salt when the lamp is pulverized as a result of disposal. The method of U.S. Pat. No. 5,229,687 employs a chemical agent, enclosed within the lamp, suitable for electrochemically reducing a substantial portion of the soluble mercury to elemental mercury, again when the lamp is pulverized during disposal. Preferably, this chemical agent is an element which has an electrode potential for oxidation reactions higher than mercury but which is not sufficiently active to displace hydrogen from acidic aqueous solutions. In a preferred embodiment, the chemical agent is sealed within an enclosure (e.g., glass), which is rupturable upon pulverization of the lamp. In another embodiment, the chemical agent is mixed with the basing cement used to secure the lamp bases to the glass envelope. The chemical agent acts to reduce soluble mercury produced during lamp operation to elemental mercury, which is not leachable as measured by the TCLP.

The chemical agent employed in '687 may be used in various forms, e.g., as a powder, dust, wire mesh, or metallic foil. The amount or size of the chemical agent is directly related to the surface area and surface condition, finely divided metallic powders being preferred over a solid mass because of their relatively large effective surface areas. Because of their availability and inexpensive cost, iron and copper, in the form of a powder or dust, are preferred. The amount of chemical agent present should be sufficient to electrochemically reduce the amount of soluble mercury within the lamp which is leached at the time of disposal to less than 0.2 milligram per liter of an aqueous acid solution such as a sodium acetate buffer solution as prescribed in the TCLP.

However, there are several disadvantages to the methods described in U.S. Pat. No. 5,229,686 and '687. In regard to '686, the quantity of chemical agent required to chemically combine nearly all of the mercury within a fluorescent lamp may be so large as to be inconvenient or impossible to contain within a standard lamp envelope. In regard to '687, the metallic copper or iron reduces the amount of leachable mercury via a surface redox reaction between adsorbed mercury ions and zero-valent metal atoms. In order for this reaction to occur, the dissolved ionic mercury must first find its way to and become adsorbed upon the metal surface. Thus, the effectiveness of a metallic element as a means of reducing leachable mercury will ultimately be limited by the rates at which mercury ions diffuse to the metal surface and become adsorbed thereon. A means of reducing leachable mercury that did not depend upon the chance contact between dissolved mercury ions and a metal surface followed by the adsorption of the mercury upon that surface would be likely to be more efficient and, therefore, preferable.

It may also be difficult or impossible to incorporate a sufficiently large quantity of a finely divided metal within a fluorescent lamp, the more so the smaller or more compact the lamp. In a small lamp, the only convenient way to introduce the metal may be as a component of the basing cement. However, the electrical conductivity of the metal may prevent its incorporation into the basing cement since the cement may easily come into contact with internal electrical leads. On the other hand, electrically insulating materials might easily be added to the basing cement in addition to or in place of the normal CaCO₃ cement filler without risk of creating electrical short circuits within the lamp.

In U.S. Pat. No. 5,736,813, it is disclosed that “the formation of leachable mercury upon disposal or during TCLP testing of mercury vapor discharge lamps is substantially prevented by incorporation of a pH control agent in the lamp structure or in the test solution to provide a pH of about 5.5 to 6.5.” A low pressure mercury discharge lamp is claimed which includes about 5-15 grams of a pH control agent (generally a water-soluble base) which, it is suggested, is sufficient to substantially prevent formation of ferric and cupric compounds which oxidize elemental mercury to a soluble form. The primary disadvantage of this method of reducing mercury leaching is that it may be difficult or, depending upon the lamp type, practically impossible to package the relatively large amounts of the required pH control agent (5-15 grams) within the structure of a typical mercury vapor lamp.

In U.S. Pat. No. 5,994,838 an improved mercury vapor discharge lamp is described in which an effective amount of a nonmetallic copper-containing compound which, when the lamp is pulverized to granules and subjected to a suitable aqueous acid solution, dissolves in the acid solution, resulting in a concentration of extracted mercury less than 0.2 mg per liter of solution. The effective amount of soluble copper is relatively small (between 0.1 and 4 mg per gram of total lamp weight, depending upon lamp type and size, total mercury loading, etc.). However, copper in the environment, although relatively harmless, may be toxic to certain marine invertebrates. In order to eliminate the possibility of damage to ecological systems, the EPA has placed a limit of 25 mg/L for copper levels in discharges from nonferrous operations to lakes and streams. It is desirable, therefore, to minimize the amount of soluble copper, which is effective with respect to the control of mercury leaching. Further, the smaller the quantity of nonmetallic copper-containing compound, the more easily it will be to incorporate within the lamp.

Even more recently it has been reported that a relatively small quantity of a divalent-manganese containing compound soluble in the aqueous acid solution employed in the TCLP, which may be incorporated in the lamp in any one of a variety of ways, substantially reduces the amount of mercury that may be leached from the lamp as determined by the standard TCLP.

The use of so-called noble metals and metal salts has also been suggested for the control of mercury leaching in fluorescent lamps. U.S. Pat. No. 6,515,421 describes a method and apparatus for preventing the formation of leachable mercury in mercury arc vapor discharge lamps, which comprises coating at least one of the metallic components of the lamp with at least one noble metal coating (typically silver or palladium). A method and apparatus for preventing the formation of leachable mercury in mercury arc vapor discharge lamps which comprises providing in the lamp structure an effective amount of a silver salt, gold salt, or combination thereof, is described in U.S. Pat. No. 6,853,118. While these methods may be effective for the control of leachable mercury, they are generally not practical due to the relatively high costs of the noble metals and metal salts. However, the use of such noble metals or metal salts might become practical if a relatively inexpensive means were found to substantially reduce the amounts of these substances which are required to effectively reduce or control mercury leaching. In addition to the above, two methods have recently been disclosed by which to lower the amounts of the expensive noble metals that are needed to effectively inhibit the leaching of mercury from a mercury vapor discharge lamp:

1) A relatively small amount of a soluble nonmetallic copper-containing compound used in combination with a small quantity of metallic silver or a compound of silver, platinum, or gold may be much more effective in preventing mercury leaching than either the copper-containing compound or the metallic silver or compound of silver, platinum, or gold used alone. Thus, as a result of the presence of a small amount of metallic silver or a compound of silver, platinum, or gold, concentrations of extracted mercury much less than 0.2 mg per liter of solution may be obtained with quantities of soluble copper-containing compounds substantially smaller than would be required to achieve the same extracted mercury concentrations in the absence of the metallic silver or compound of silver, platinum, or gold. Conversely, as a result of the presence of a relatively small amount of a soluble copper-containing compound, concentrations of extracted mercury much less than 0.2 mg per liter of solution may be obtained with quantities of metallic silver or of compounds of silver, platinum, or gold substantially smaller than would be required to achieve the same extracted mercury concentrations in the absence of the dissolved copper compound.
2) Similarly, a relatively small amount of a soluble nonmetallic manganese-containing compound used in combination with a small quantity of metallic silver or a compound of silver may be much more effective in preventing mercury leaching than either the manganese-containing compound or the metallic silver or compound of silver used alone. Thus, as a result of the presence of a small amount of metallic silver or a compound of silver, concentrations of extracted mercury much less than 0.2 mg per liter of solution may be obtained with quantities of soluble manganese-containing compounds substantially smaller than would be required to achieve the same extracted mercury concentrations in the absence of the metallic silver or compound of silver. Conversely, as a result of the presence of a relatively small amount of a soluble manganese-containing compound, concentrations of extracted mercury much less than 0.2 mg per liter of solution may be obtained with quantities of metallic silver or of compounds of silver substantially smaller than would be required to achieve the same extracted mercury concentrations in the absence of the dissolved manganese compound.

The combination of a relatively small amount of a divalent-manganese-containing compound with a relatively small amount of a copper-containing compound is particularly effective for the control or inhibition of mercury leaching from a mercury-containing gas-discharge lamp. Moreover, the combined amount of said divalent-manganese-containing compound and the copper-containing compound is substantially smaller than both the amount of said manganese-containing compound that would be required to produce said concentration of extracted mercury in the absence of the said copper-containing compound and the amount of said copper-containing compound that would be required to produce said concentration of extracted mercury in the absence of the said manganese-containing compound. Moreover, as a result of the above described synergy between manganese-containing and copper-containing compounds, the total amount of material required to control mercury leaching may be reduced, resulting in cost savings and, possibly, improved processability in manufacturing. Alternatively, better control or inhibition of mercury leaching may be achieved without incurring either additional manufacturing costs or processability problems.

While all of the above solutions are workable to some extent, all have some problems. It would be an advance in the art to provide a better solution to the art of land filling mercury-containing lamps.

### DISCLOSURE OF INVENTION

It is, therefore, an object of the invention to obviate the disadvantages of the prior art.

It is another object of the invention to enhance mercury removal.

It is another object of the invention to improve the control of mercury leaching.

These objects are accomplished, in one aspect of the invention, by associating with a mercury-containing lamp a tri-partite component containing an effective amount of materials to allow said lamp to safely be disposed of, the materials comprising a divalent manganese compound, a copper containing compound and a compound selected from the group consisting of metallic silver and silver containing compounds. The employment of the three components allows the use of very small quantities, the total amount being smaller than when any one of the components is used alone or when any two of the components are used together.

### BRIEF DESCRIPTION OF THE DRAWINGS

FIG. 1 is a diagrammatic view of a lamp employing an embodiment of the invention; and

FIG. 2 is similar view of an alternate embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the invention with greater particularity, it has been found that a safely disposable mercury-containing discharge lamp can be manufactured by associating with the lamp a tri-partite component comprising an effective amount of a divalent manganese compound, a copper containing compound and a compound selected from the group consisting of metallic silver and silver containing compounds.

The combined amount of these three materials is generally substantially smaller than the required amount of any one of these materials used alone or any two of these three materials used together. This synergy results in major savings for the lamp manufacturer.

A broad range of materials is available for inclusion with the lamp. For example, any divalent-manganese-containing compound that is soluble in the TCLP extraction fluid can be used as a source of the divalent manganese. The list of such compounds includes, for example, manganese acetate, manganese bromide, manganese chloride, manganese iodide, manganese sulfate, manganese nitrate, manganese sulfide and manganese carbonate. Of these, manganese carbonate is preferred since it is soluble in the TCLP extraction fluid but is insoluble in non-acidic media. Moreover, it is the most easily incorporated into the lamp structure as a substitute for a portion of the inert calcium carbonate basing-cement filler material.

Likewise, any copper-containing compound that is soluble in the TCLP extraction fluid can be used as a source of copper. The list of such compounds includes (but is not limited to) copper sulfate, copper acetate, copper dihydroxy carbonate, copper oxide, copper chloride, copper bromide, and copper hydroxide. Copper dihydroxy carbonate, however, is the most preferred compound since it is soluble in the acidic TCLP extraction fluid but is insoluble in non-acidic media. Moreover, it, too, is most easily incorporated into the lamp structure as a substitute for a portion of the inert CaCO₃ basing-cement filler material.

Likewise, any silver-containing compound that is soluble in the TCLP extraction fluid can be used as a source of silver. The list of such silver compounds includes (but is not limited to) silver oxide, silver carbonate, silver chloride, silver sulfate, silver acetate, silver nitrate, and silver sulfide, as well as finely divided metallic silver. Silver carbonate, however, is the most preferred compound since it is readily soluble in the acidic TCLP extraction fluid but is insoluble in non-acidic media. Moreover, it is easily incorporated into the lamp structure as a substitute for a portion of the inert CaCO₃ basing-cement filler material.

### EXAMPLE I

A series of 12 TCLP tests were carried out with commercial 32WT8 fluorescent lamps manufactured without metallic mercury but with 6 mg of ionic mercury (as HgO, soluble in the TCLP extraction fluid) added at the start of each test. One test was run without the addition of any compound of copper, manganese, or silver. However, each of the other 11 tests included a quantity of silver carbonate (Ag₂CO₃) and/or manganese carbonate (MnCO₃, hereafter referred to as MNC) and/or copper dihydroxy carbonate (Cu₂(OH)₂CO₃, hereafter referred to as CDC). The TCLP test results are listed in Table I, which is organized according to the milli-moles (10⁻³) of Cu²⁺ (as CDC), milli-moles of Mn²⁺ (as MNC), and mg of Ag (as Ag₂CO₃) that were added at the start of the test.

TABLE I
TCLP Results (mg of Extracted Hg per liter of Extraction Fluid) for T8 Lamps
Manufactured without Metallic Hg but with 6 mg Ionic Hg (as HgO) and the Indicated
Quantities of Ag (as Ag₂CO₃), Cu (as CDC), and Mn (as MNC) Added at the Start of
Each Test

| Mole × 10⁻³ | Mole × 10⁻³ | TCLP Results with | TCLP Results with | TCLP Results with |
|---|---|---|---|---|
| Cu | Mn | 0 mg Ag (as | 1 mg Ag (as | 3 mg Ag (as |
| (as CDC) | (as MNC) | Ag₂CO₃) | Ag₂CO₃) | Ag₂CO₃) |
| 0 | 0 | 0.82 | 0.68 | 0.38 |
| 0.8 | 0 | 0.32 | 0.25 | 0.09 |
| 0 | 0.8 | 0.30 | 0.24 | 0.07 |
| 0.4 | 0.4 | 0.21 | 0.08 | 0.04 |

As shown, a combination of all three compounds results in the most effective control of mercury leaching. That is to say, the amount of copper-containing, manganese-containing, and silver-containing compounds needed to reduce the extracted mercury concentration to well below the 0.2 mg/l level is smallest when the three compounds are used in combination. Thus, a 1:1 mixture of copper and manganese (4×10⁻⁴ mole quantities of Cu and of Mn as CDC and MnCO₃, respectively) combined with only 1 mg of silver (as Ag₂CO₃) yields about the same extracted mercury concentration as does the equivalent amount (8×10⁻⁴ mole) of Cu or of Mn combined with 3 times as much (3 mg) of silver.

### EXAMPLE 2

Additional TCLP tests were carried out in the same way as those described above. Two tests were run with the addition of 2 mg of silver (as Ag₂CO₃), with and without the addition of a 1:1 mixture Cu (4×10⁻⁴ mole as CDC) and of Mn (4×10⁻⁴ mole as MnCO₃). Additional tests were run with 0, 1, or 2 mg of Ag (as Ag₂CO₃) combined with various 1:1 mixtures of Cu (as CDC) and of Mn (as MnCO₃). The results of these tests, along with some of those that were described in Example 1, are listed in Table 2 below.

TABLE II
TCLP Results (mg of Extracted Hg per liter of Extraction Fluid)
for T8 Lamps Manufactured without Metallic Hg but with 6 mg
Ionic Hg (as HgO) and the Indicated Quantities of Ag (as
Ag₂CO₃) and a 1:1 Mixture of Cu (as CDC) and Mn (as MNC)

| | | TCLP | TCLP | TCLP |
|---|---|---|---|---|
| | | Results | Results | Results |
| | | with | with | with |
| | TCLP Results | 2 × 10⁻⁴ | 4 × 10⁻⁴ | 6 × 10⁻⁴ |
| Ag (mg) | without Cu or | mole Cu and | mole Cu and | mole Cu and |
| As Ag₂CO₃ | Mn | Mn | Mn | Mn |
| 0 | 0.82 | 0.42 | 0.21 | 0.08 |
| 1 | 0.68 | 0.29 | 0.08 | 0.02 |
| 2 | 0.50 | 0.15 | 0.05 | 0.02 |

As shown, the extent of mercury leaching decreases both with the amount of silver and with the amount of a 1:1 mixture of Cu and Mn that is used in combination with the silver.

### EXAMPLE 3

Overall, in the absence of the 1:1 mixture of Cu and Mn, between 5 and 10 times as much silver is required to achieve a particular degree of mercury-leaching control as is needed when the silver is combined with Cu and Mn.

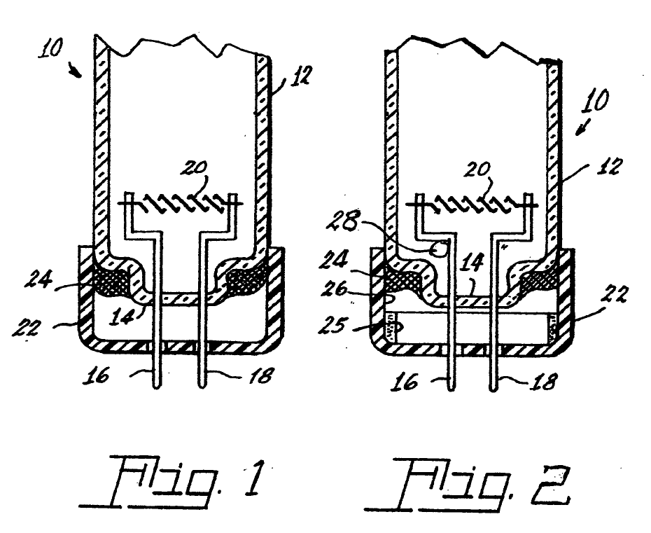

The tri-partite compound can be introduced into a lamp, for example, a fluorescent lamp 10 shown in FIGS. 1 and 2, by various means. The lamp 10 has an envelope 12 sealed at one end 14. Two electrical lead-ins 16, 18 are sealed into the end 14 and extend into the interior of the envelope and mount a filamentary cathode 20. The lead-ins 16 and 18 project from a base 22 to the exterior of the lamp for connection to a power source. The base 22 is cup-shaped and is sealed to the envelope 12 by a basing cement 24, which can be formulated to include the tri-partite compound.

Alternatively, the lamp can contain the tripartite compound as a coating 25 applied to the inside surface 26 of the base or be contained within a sealed, rupturable container 28, which, preferably, is made of glass.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. In a mercury-containing lamp, wherein at least a quantity of said mercury is in the form of elemental mercury at least partially convertible to soluble mercury, the improvement comprising:
associating with said lamp a component containing an effective amount of materials to allow said lamp to safely be disposed of, said materials forming a tri-partite component comprising a divalent manganese compound, a copper containing compound and a compound selected from the group consisting of metallic silver and silver containing compounds.

2. The lamp of claim 1 wherein said soluble mercury is present as mercury oxide.

3. The lamp of claim 1 wherein said tri-partite component is located in a base of said lamp.

4. The lamp of claim 1 wherein said tri-partite component is contained within a rupturable capsule contained within said lamp.

5. The lamp of claim 1 wherein said tri-partite component forms a part of a basing cement used to attach a base to said lamp.

6. The lamp of claim 1 wherein said compounds are mixed with a basing cement securing a lamp base portion to said envelope.

7. The lamp of claim 1 where said manganese compound comprises a compound selected from a group of compounds, said group consisting of manganese acetate, manganese bromide, manganese chloride, manganese iodide, manganese sulfate, manganese nitrate, manganese sulfide, and manganese carbonate.

8. The lamp of claim 1 where said copper-containing compound comprises a compound selected from a group of compounds, said group consisting of copper sulfate, copper acetate, copper dihydroxy carbonate, copper oxide, copper chloride, copper bromide, and copper hydroxide.

8. The lamp of claim 1 where said silver-containing compound comprises a compound selected from a group of compounds, said group consisting of silver oxide, silver carbonate, silver chloride, silver sulfate, silver acetate, silver nitrate, and silver sulfide, as well as finely divided metallic silver.

9. The lamp of claim 1 wherein the said divalent-manganese-containing compound is manganese carbonate, said copper-containing compound is copper dihydroxy carbonate, and said silver-containing compound is silver carbonate.
